(19) United States
(12) Patent Application Publication
(10) Pub. No.: US 2025/0180413 A1
(43) Pub. Date: Jun. 5, 2025

(54) INTENSITY MEASURING DEVICE, INTENSITY MEASURING SYSTEM, AND INTENSITY MEASURING METHOD

(71) Applicant: SINTOKOGIO, LTD., Nagoya-shi (JP)

(72) Inventor: Akinori MATSUI, Nagoya-shi (JP)

(73) Assignee: SINTOKOGIO, LTD., Nagoya-shi (JP)

(21) Appl. No.: 18/941,198

(22) Filed: Nov. 8, 2024

(30) Foreign Application Priority Data
Nov. 30, 2023 (JP) 2023-203194

(51) Int. Cl. G01L 1/10; G01L 5/00

(52) U.S. Cl. CPC G01L 1/106; G01L 5/0052

(57) ABSTRACT

An intensity measuring device according to one aspect is connected to a sensor device that outputs a signal waveform related to an elastic wave generated by shot processing, and measures an intensity of the shot processing based on the signal waveform. The intensity measuring device includes a waveform acquisition unit configured to acquire the signal waveform from the sensor device; a time-series data generation unit configured to generate time-series data of an effective value of the signal waveform; an average value acquisition unit configured to obtain an average value of the effective values for a predetermined time length based on the time-series data; and an intensity acquisition unit configured to obtain the intensity of the shot processing based on the average value of the effective values.

### CROSS-REFERENCE TO RELATED APPLICATIONS

This application is based on and claims the benefit of priority from Japanese Patent Application No. 2023-203194 filed on Nov. 30, 2023, the entire contents of which are incorporated herein by reference.

### TECHNICAL FIELD

The present disclosure relates to an intensity measuring device, an intensity measuring system, and an intensity measuring method.

### BACKGROUND

In shot processing such as shot blasting or shot peening, shot media are projected onto a processing object. When the shot processing is performed, it is required to cause the shot media to collide with the processing object with an appropriate strength so that the processing object is in an appropriate processing state according to an application.

In general, an intensity is used as an index quantitatively representing the strength of the shot processing. The intensity corresponds to an arc-height at a time point when an increase rate of the arc-height read from a peening time-arc-height saturation curve, which is created after the arc-height (warpage amount of the test piece) is measured after the shot processing of a test piece for an arbitrary time, falls within 10%. Specification of U.S. Pat. No. 2,350,440 describes a metal plate used as the test piece for measuring the intensity. The metal plate for measuring the intensity is also called an Almen strip.

### SUMMARY

### Technical Problem

In order to acquire the arc-height saturation curve, it is necessary to measure the arc-height by projecting the shot media onto a plurality of Almen strips. The Almen strip is not preferable from the viewpoint of cost and environmental load because it cannot be reused and thus generates waste. In addition, since it takes a lot of time and effort to measure an arc-height value by using a microgauge to acquire the arc-height saturation curve, there is a problem that it takes time to measure the intensity.

Therefore, an object of the present disclosure is to provide an intensity measuring device, an intensity measuring system, and an intensity measuring method capable of efficiently measuring an intensity.

### Solution to Problem

An intensity measuring device according to one aspect is connected to a sensor device that outputs a signal waveform related to an elastic wave generated by shot processing, and measures an intensity of the shot processing based on the signal waveform. The intensity measuring device includes a waveform acquisition unit, a time-series data generation unit, an average value acquisition unit, and an intensity acquisition unit. The waveform acquisition unit acquires a signal waveform from the sensor device. The time-series data generation unit generates time-series data of an effective value of the signal waveform. The average value acquisition unit obtains an average value of the effective values in a predetermined time length based on the time-series data. The intensity acquisition unit obtains an intensity of the shot processing based on the average value of the effective values.

### Advantageous Effects of Invention

According to various aspects of the present disclosure, an intensity can be efficiently measured.

### BRIEF DESCRIPTION OF THE DRAWINGS

FIG. 1 is a diagram schematically illustrating a shot processing system according to an embodiment;

FIG. 2A is a perspective diagram of an exemplary sensor device, and FIG. 2B is an exploded perspective diagram illustrating main components of the sensor device;

FIG. 3 is a diagram illustrating a functional configuration of an intensity measuring device;

FIG. 4 is a diagram illustrating an example of a signal waveform output from the sensor device;

FIG. 5 is a diagram illustrating a temporal change in an effective value of the signal waveform;

FIG. 6 is a graph illustrating a relationship between an average value of the effective values and an intensity of shot processing;

FIG. 7 is a diagram illustrating a first configuration example of the intensity measuring device;

FIG. 8 is a diagram illustrating a second configuration example of the intensity measuring device; and

FIG. 9 is a flowchart illustrating an intensity measuring method according to the embodiment.

### DETAILED DESCRIPTION

Hereinafter, an embodiment of the present disclosure will be described with reference to the drawings. Note that in the following description, the same or equivalent elements are denoted by the same reference signs, and redundant description will not be repeated. The dimensional ratios in the drawings do not necessarily coincide with those in the description.

### Example of Embodiment of Present Disclosure

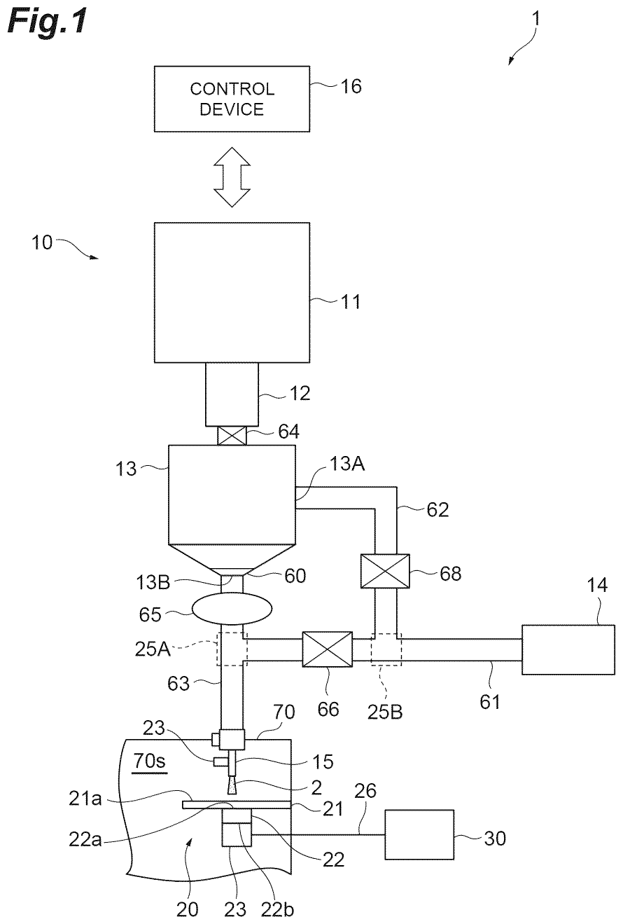

FIG. 1 is a diagram schematically illustrating a shot processing system according to an embodiment. A shot processing system 1 illustrated in FIG. 1 projects shot media under a set projection condition. Note that in the present specification, processing of projecting a shot medium from a shot processing device is referred to as shot processing. The shot processing includes shot blasting for the purpose of scale removal, deburring, surface roughness adjustment, and the like, and shot peening for the purpose of applying a compressive residual stress to a processing object.

As illustrated in FIG. 1, the shot processing system 1 includes a shot processing device 10, a sensor device 20, and an intensity measuring device 30. The shot processing device 10 projects the shot media onto the processing object and causes the shot media to collide with the processing object, thereby processing a surface of the processing object. For example, the shot processing device 10 is a shot peening device that applies the compressive residual stress to the surface of the processing object. Examples of the processing object on which the shot processing is performed by the shot processing device 10 include automobile components such as cylinder heads and crankshafts, gears, and molds, but the processing object is not limited thereto. By applying the compressive residual stress to the surface of the processing object by the shot processing, fatigue characteristics of the processing object are improved.

The compressive residual stress to be applied to the processing object is determined according to the application of the processing object. In order to apply the compressive residual stress required to the processing object, it is required to perform shot processing with an appropriate strength to the processing object. In general, an intensity is used as an index quantitatively representing the strength of the shot processing. The intensity corresponds to an arc-height at a time point when an increase rate of the arc-height read from a peening time-arc-height saturation curve, which is created after an arc-height value is measured after the shot processing of a test piece for an arbitrary time, falls within 10%. A method of calculating the intensity is defined in SAE standard J443 (2010).

The shot processing device 10 may be an air type in which shot media are injected as a solid-gas two-phase flow together with compressed air, or may be a centrifugal type in which shot media are projected by a centrifugal force due to rotation of an impeller called an impeller. The shot processing device 10 illustrated in FIG. 1 is a direct pressure type shot peening device. The shot processing device 10 may be a suction type or gravity type shot peening device. The shot processing device 10 may be a wet shot peening device. A material of the shot media 2 projected onto the processing object may be, for example, an iron-based metal such as steel or iron, a non-ferrous metal such as stainless steel, or a non-metal such as glass or zirconia. A shape of the shot media 2 may be spherical, or may be obtained by rounding corners of a granular material (so-called cut wire) obtained by cutting a wire drawing to a predetermined length. As the shot media 2, for example, steel balls are used. The material, shape, and particle size of the shot media 2 are appropriately selected according to the compressive residual stress to be applied to the processing object.

As illustrated in FIG. 1, the shot processing device 10 includes a shot media tank 11, a shot media supply device 12, a pressurizing tank 13, a compressor 14, a nozzle 15, and a control device 16. The shot media tank 11 stores the shot media 2. The shot media tank 11 is connected to the pressurizing tank 13 via the shot media supply device 12. An openable and closable poppet valve 64 is provided between the shot media supply device 12 and the pressurizing tank 13. When the poppet valve 64 is opened, the shot media 2 stored in the shot media tank 11 is supplied to the pressurizing tank 13 via the shot media supply device 12.

The compressor 14 generates compressed air and supplies the compressed air to the pressurizing tank 13 and the nozzle 15. One end of a pipe 61 is connected to the compressor 14. The other end of the pipe 61 is connected to a pipe 63 described later. A pipe 62 branches from a position between one end and the other end of the pipe 61. The pipe 62 is connected to an air inflow port 13A of the pressurizing tank 13. The pipe 62 is provided with an air flow rate adjusting valve 68. The air flow rate adjusting valve 68 adjusts a flow rate of the compressed air flowing through the pipe 62. When the air flow rate adjusting valve 68 is opened, the compressed air from the compressor 14 is supplied to the pressurizing tank 13 via the pipe 61 and the pipe 62. When the compressed air is supplied from the compressor 14 to the pressurizing tank 13, the inside of the pressurizing tank 13 is pressurized.

The pressurizing tank 13 has a shot outflow port 13B through which the shot media 2 flow out. The shot outflow port 13B is provided with an openable and closable cut gate 60. A pipe 63 is connected to the shot outflow port 13B via the cut gate 60. The pipe 63 is provided with a shot amount adjusting valve 65 that adjusts an amount of the shot media 2 injected from the nozzle 15. The other end of the pipe 61 is connected to the pipe 63. The connection portion between the pipe 61 and the pipe 63 configures a mixing portion 25A in which the shot media 2 supplied from the pressurizing tank 13 and the compressed air supplied from the compressor 14 are mixed. The mixing portion 25A is located on a downstream side of a branch portion 25B where the pipe 62 branches from the pipe 61 in a flow direction of the compressed air.

An air flow rate adjusting valve 66 is provided at a position between the mixing portion 25A and the branch portion 25B in the pipe 61. The air flow rate adjusting valve 66 adjusts a flow rate of the compressed air supplied from the compressor 14 to the nozzle 15. The compressed air whose flow rate has been adjusted by the air flow rate adjusting valve 66 is mixed with the shot media 2 supplied from the pressurizing tank 13 in the mixing portion 25A and sent to the nozzle 15.

The nozzle 15 is provided at a tip of the pipe 63, and injects the shot media 2 supplied from the pressurizing tank 13 as a solid-gas two-phase flow together with compressed air. The nozzle 15 is disposed inside a cabinet 70. The cabinet 70 defines a processing chamber 70s that is a space for processing a processing object. In a case of performing shot processing on the processing object, the processing object is disposed in the processing chamber 70s, the shot media 2 are projected from the nozzle 15 toward the processing object in the processing chamber 70s, and the shot media 2 are caused to collide with the processing object.

The control device 16 is a computer including a processor, a storage device, an input device, a display device, a communication device, and the like, and controls the entire operation of the shot processing device 10. The control device 16 loads, for example, a program stored in the storage device, and executes the loaded program by the processor to implement various functions described later. In the control device 16, an operator can perform a command input operation or the like to manage the shot processing device 10 using the input device, and an operating state of the shot processing device 10 can be visualized and displayed by the display device.

The control device 16 determines a projection condition of the shot media 2 of the shot processing device 10 and controls the shot processing device 10 to project the shot media 2 under the determined projection condition. Here, the projection condition is a condition set in the shot processing device 10 to project the shot media 2, and examples thereof include an injection pressure of the shot media 2 and an injection amount of the shot media 2.

Although not illustrated in FIG. 1, the shot processing device 10 may further include a dust collector, a classifying device, and a circulating device for reusing the used shot media 2. The dust collector is connected to the processing chamber 70s via the classifying device, and sucks the shot media 2 falling into a lower part of the processing chamber 70s and chips of the processing object to transfer the shot media 2 and the chips to the classifying device. The classifying device is, for example, a cyclone type classifying device, and receives the shot media 2 and the chips of the processing object and classifies them into particles that can be reused as the shot media 2 and particles that cannot be used as the shot media 2. The circulating device returns the reusable shot media 2 to the shot media tank 11 via a packet elevator, a screw conveyor, a separator, and the like.

As described above, the shot media 2 projected from the nozzle 15 of the shot processing device 10 collides with the processing object. When the collision of the shot media 2 cause a force of tapping and stretching to act on the surface of the processing object, a reaction force against the force is generated in the processing object. As a result, a compressive residual stress is applied to the processing object.

In the shot processing system 1, in order to confirm whether or not an intensity of the shot processing matches a required intensity, the sensor device 20 is subjected to the shot processing before the shot processing is performed on the processing object, and the intensity of the shot processing is measured. Then, it is periodically confirmed whether or not the measured intensity matches the required intensity. The measurement of the intensity is performed once or a plurality of times, for example, before the shot processing of the processing object.

When the shot media 2 collide with an object by the shot processing, a phenomenon called acoustic emission in which elastic energy inside the object is emitted as an elastic wave occurs along with deformation or destruction of the object. The elastic wave is a wave such as vibration or a sound wave generated in the object by the collision of the shot media 2. The sensor device 20 measures the elastic wave generated when the shot media 2 collide, and outputs a signal waveform (hereinafter, referred to as an “AE signal waveform”) indicating the measured elastic wave.

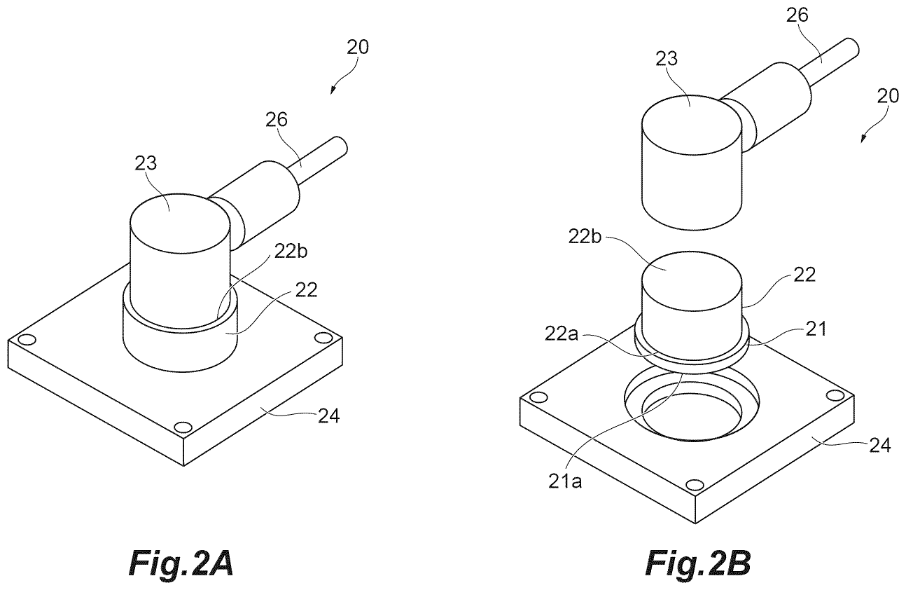

FIG. 2A is a perspective diagram of an exemplary sensor device 20, and FIG. 2B is an exploded perspective diagram of main components of the sensor device 20. As illustrated in FIGS. 2A and 2B, the sensor device 20 includes a collision member 21, a waveguide member 22, and an AE sensor 23. The collision member 21 is a plate made of a hard material having abrasion resistance, and has a surface 21a that receives the shot media 2 projected from the shot processing device 10. The collision member 21 is fixed to a cover 24 such that the surface 21a is exposed.

The waveguide member 22 has a substantially cylindrical shape and has a first surface 22a and a second surface 22b disposed on the opposite side of the first surface 22a. The first surface 22a is in contact with a surface of the collision member 21 opposite to the surface 21a. When the shot media 2 collide with the surface 21a of the collision member 21, an elastic wave generated in the collision member 21 is propagated from the first surface 22a to the second surface 22b.

The AE sensor 23 is, for example, a piezoelectric element that measures an elastic wave. The AE sensor 23 is in contact with the second surface 22b of the waveguide member 22, measures the elastic wave propagated to the second surface 22b of the waveguide member 22, and outputs an AE signal waveform indicating the measured elastic wave. The AE signal waveform is a voltage waveform indicating an amplitude of the elastic wave. The sensor device 20 outputs the AE signal waveform measured by the AE sensor 23 to the intensity measuring device 30.

Note that the sensor device 20 may not include the collision member 21 depending on a material of the shot media 2 or a projection condition. In this case, the first surface 22a of the waveguide member 22 is exposed from the cover 24, and the shot media 2 collide with the first surface 22a of the waveguide member 22. Then, the AE sensor 23 measures the elastic wave propagated from the first surface 22a to the second surface 22b of the waveguide member 22.

The intensity measuring device 30 is communicably connected to the sensor device 20 via a cable 26. Note that the intensity measuring device 30 may be connected to the sensor device 20 by wireless communication. The intensity measuring device 30 measures (estimates) an intensity of the shot processing based on the AE signal waveform output from the sensor device 20.

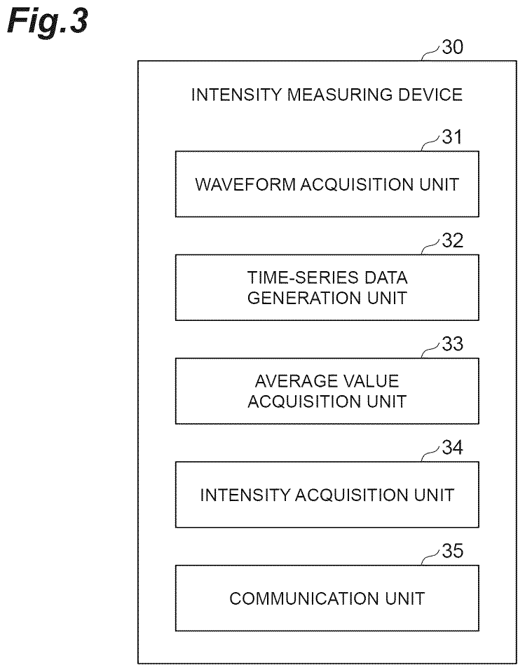

FIG. 3 is a diagram illustrating a functional configuration of the intensity measuring device 30. As illustrated in FIG. 3, the intensity measuring device 30 includes a waveform acquisition unit 31, a time-series data generation unit 32, an average value acquisition unit 33, an intensity acquisition unit 34, and a communication unit 35 as functional components.

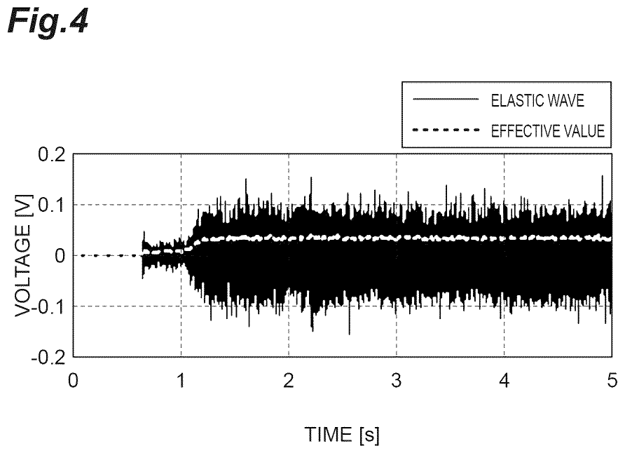

The waveform acquisition unit 31 acquires an AE signal waveform from the sensor device 20. FIG. 4 illustrates an example of the AE signal waveform output from the sensor device 20 when the shot media 2 collide with the surface 21a of the sensor device 20. As illustrated in FIG. 4, the AE signal waveform is a waveform whose amplitude fluctuates with time.

The time-series data generation unit 32 generates time-series data of an effective value of the AE signal waveform. The effective value means a root mean square of the amplitude of the AE signal waveform at a duration T of the AE signal waveform. Specifically, when the amplitude of the AE signal waveform is represented as a function f(t) of a time t, an effective value RMS can be obtained from the following Equation (1).

$$[ Equation 1 ]$$

$$RMS = \sqrt{\frac{1}{T} {\int }_{0}^{T} {f ( x )}^{2} dt} \qquad ( 1 )$$

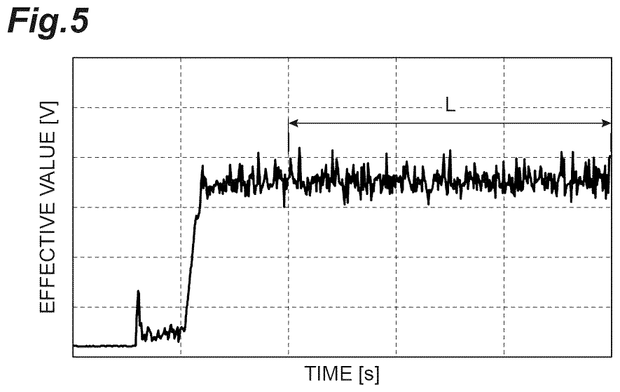

FIG. 5 is data indicating the effective value of the AE signal waveform illustrated in FIG. 4. As illustrated in FIG. 5, it can be said that the effective value of the AE signal waveform is time-series data that changes with time.

The average value acquisition unit 33 obtains an average value of the effective values for a predetermined time length L based on the generated time-series data of the effective value. The predetermined time length L is a set value set by a designer, and is, for example, 3 seconds. For example, when the effective value at a time ti (i=1, 2, . . . , and n) within the predetermined time length L is RMSi, an average value RMSₐᵥᵣ of the effective values can be obtained by the following Equation (2). Note that in Equation (2), N is a number of samples of the effective value acquired in a sampling period Δt, and can be represented by (tn−t1)/Δt.

$$[ Equation 2 ]$$

$${RMS}_{avr} = \frac{1}{N} {\sum }_{i = 1}^{n} {RMS}_{i} \qquad ( 2 )$$

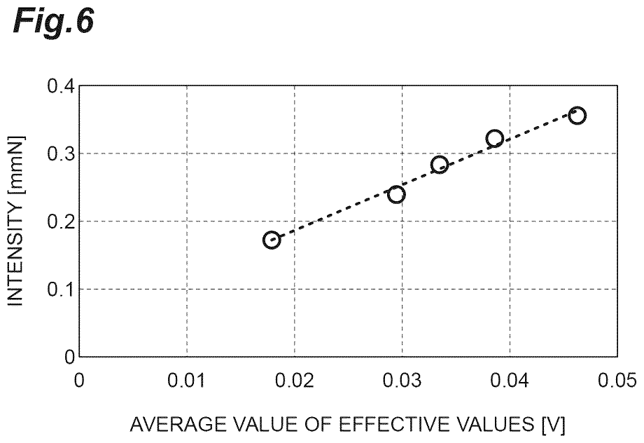

FIG. 6 is a graph illustrating a relationship between the average value of the effective values and the intensity of the shot processing. The graph is generated, for example, based on an experimental result of past shot processing. As illustrated in FIG. 6, there is a correlation between the average value of the effective values and the intensity of the shot processing. The intensity acquisition unit 34 acquires the intensity of the shot processing based on correlation data indicating the correlation between the average value of the effective values and the intensity of the shot processing.

For example, the intensity acquisition unit 34 draws an approximate straight line or an approximate curve indicating the correlation between the average value of the effective values and the intensity of the shot processing in the graph illustrated in FIG. 6, and generates a model equation indicating the correlation between the average value of the effective values and the intensity from the approximate straight line or the approximate curve. The model equation indicating the correlation between the average value of the effective values and the intensity can be represented by a polynomial with one variable illustrated in the following Equation (3). Where, in Equation (3), aₙ is a constant, x is an average value [V] of the effective values of the AE signal waveform for the predetermined time length L, and y is an intensity [mmN] of the shot processing. Note that the Equation (3) can also be represented as the following Equation (4).

$$[ Equation 3 ]$$

$$y = {a}_{n} {x}^{n} + {a}_{n - 1} {x}^{n - 1} + … + {a}_{1} x + {a}_{0} \qquad ( 3 )$$

$$[ Equation 4 ]$$

$$y = {\sum }_{k = 0}^{n} {a}_{k} {x}^{k} \qquad ( 4 )$$

The constant aₙ is set according to characteristics (material, diameter, hardness, and the like) of the shot media 2. The model equation is generated for each type of the shot media 2. The intensity acquisition unit 34 obtains an intensity using a model equation according to the type of the shot media 2. Typically, the model equation indicating the correlation between the average value of the effective values and the intensity is represented as a linear equation indicated by the following Equation (5) or a quadratic equation indicated by the following Equation (6).

$$[ Equation 5 ]$$

$$y = {a}_{1} x + {a}_{0} \qquad ( 5 )$$

$$[ Equation 6 ]$$

$$y = {a}_{2} {x}^{2} + {a}_{1} x + {a}_{0} \qquad ( 6 )$$

Note that the intensity acquisition unit 34 may acquire the intensity corresponding to the average value of the effective values by referring to a table in which the average value of the effective values and the intensity are associated with each other without using Equation (4) described above. In this case, the table in which the average value of the effective values and the intensity are associated with each other is prepared for each type of the shot media 2.

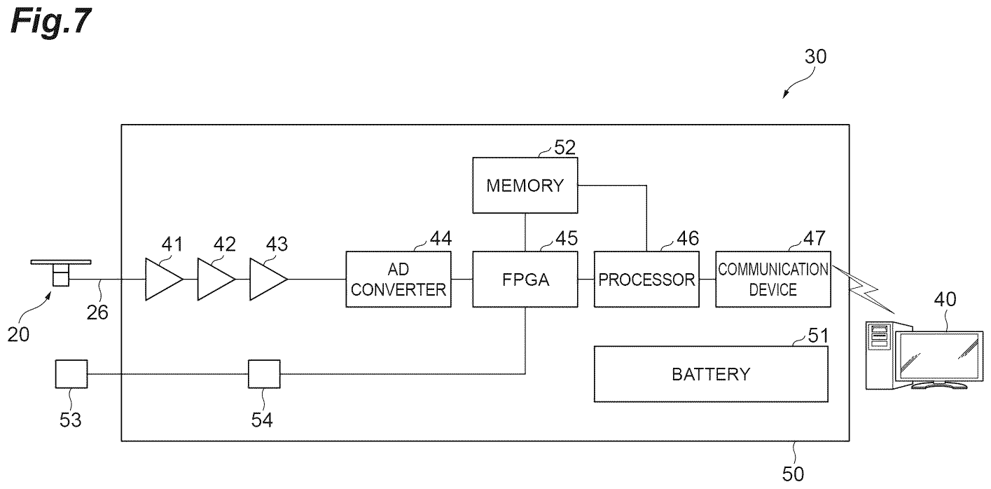

The communication unit 35 outputs data indicating the intensity acquired by the intensity acquisition unit 34 to an external device 40 by wired communication or wireless communication (see FIG. 7). The external device 40 is a computer for managing the intensity measuring device 30. The external device 40 may be a stationary or portable computer or workstation, or may be a portable terminal such as a notebook computer, a tablet terminal, a smartphone, or a PDA. The external device 40 displays the intensity output from the intensity measuring device 30 on a display device and presents the intensity to the operator of the shot processing system 1. That is, the communication unit 35 configures an output unit that outputs the intensity of the shot processing.

As described above, the intensity measuring device 30 receives the AE signal waveform from the sensor device 20 as input, and outputs the intensity of the shot processing based on the AE signal waveform. The intensity y output from the intensity measuring device 30 satisfies Equation (4) described above.

### First Configuration Example

FIG. 7 illustrates a first configuration example of the intensity measuring device 30 in which each function of the intensity measuring device 30 is mounted. As illustrated in FIG. 7, the intensity measuring device 30 according to the first configuration example includes, as physical components, a charge amplifier (amplifier) 41, a variable gain 42, a filter 43, an AD converter 44, a field programmable gate array (FPGA) 45, a processor 46, and a communication device 47. For example, the charge amplifier 41, the variable gain 42, the filter 43, the AD converter 44, the FPGA 45, the processor 46, and the communication device 47 are mounted on a same substrate 50 and operate by power of a battery 51.

The charge amplifier 41 is an amplifier circuit that amplifies an AE signal waveform. The charge amplifier 41 receives an AE signal waveform from the sensor device 20 via the cable 26, amplifies the AE signal waveform, and outputs the amplified AE signal waveform as a voltage signal. That is, the charge amplifier 41 configures the waveform acquisition unit 31 that acquires the AE signal waveform from the sensor device 20. The variable gain 42 adjusts an amplification factor (gain) of the charge amplifier 41 according to the output of the charge amplifier 41.

The filter 43 removes a high-frequency component from the AE signal waveform amplified by the charge amplifier 41. The AD converter 44 samples the AE signal waveform output from the filter 43 at a predetermined sampling frequency, and converts the AE signal waveform into digital data.

The FPGA 45 is an integrated circuit capable of programming a circuit configuration of a logic gate, and executes a predetermined operation according to a program at a high speed. The FPGA 45 calculates an effective value at each time from the digital data of the AE signal waveform based on, for example, Equation (1), and generates time-series data of the effective value. The operation of the FPGA 45 is controlled by a switching signal received from a switch 53 via a trigger 54.

In addition, the FPGA 45 calculates an average value of the effective values based on the generated time-series data of the effective value. For example, the FPGA 45 extracts a plurality of effective values included in a predetermined time length L from the time-series data and calculates an average value of the plurality of effective values. That is, the FPGA 45 configures the time-series data generation unit 32 and the average value acquisition unit 33. The predetermined time length L is stored in a memory 52, for example. The FPGA 45 stores the calculated average value of the effective values in the memory 52. The memory 52 may be built in the FPGA 45.

The processor 46 is configured by an arithmetic device such as a microcomputer or a PLC. The processor 46 reads the average value of the effective values stored in the memory 52, and calculates an intensity of the shot processing based on the average value of the effective values. For example, a model equation according to a type of the shot media 2 is read from the memory 52, and an intensity corresponding to the average value of the effective values is calculated using the model equation. As the model equation used for calculating the intensity, Equation (4) described above is used. That is, the processor 46 configures the intensity acquisition unit 34.

Note that the generation processing of the time-series data of the effective value, the calculation processing of the average value of the effective values, and the calculation processing of the intensity may be allocated to either the FPGA 45 or the processor 46. For example, the FPGA 45 may execute the generation processing of the time-series data of the effective value, the calculation processing of the average value of the effective values, and the calculation processing of the intensity. In this case, the FPGA 45 configures the time-series data generation unit 32, the average value acquisition unit 33, and the intensity acquisition unit 34. In addition, only the generation processing of the time-series data of the effective value may be allocated to the FPGA 45, and the calculation processing of the average value of the effective values and the calculation processing of the intensity may be allocated to the processor 46. In this case, the FPGA 45 configures the time-series data generation unit 32, and the processor 46 configures the average value acquisition unit 33 and the intensity acquisition unit 34.

The communication device 47 is a device that communicates with the external device 40 by wired communication or wireless communication. Examples of the wired communication or wireless communication include LAN, Bluetooth (registered trademark), Wi-Fi, and the like. The communication device 47 transmits information indicating the calculated intensity of the shot processing to the external device 40. The intensity received by the external device 40 is displayed on a display device of the external device 40.

As described above, in the intensity measuring device 30 according to the first configuration example, since the generation processing of the time-series data of the effective value for which a large calculation load is required is allocated to the FPGA 45, it is possible to increase a measurement speed of the intensity. Furthermore, since the charge amplifier 41, the variable gain 42, the filter 43, the AD converter 44, the FPGA 45, the processor 46, and the communication device 47 are mounted on the same substrate 50, the intensity measuring device 30 can be downsized.

### Second Configuration Example

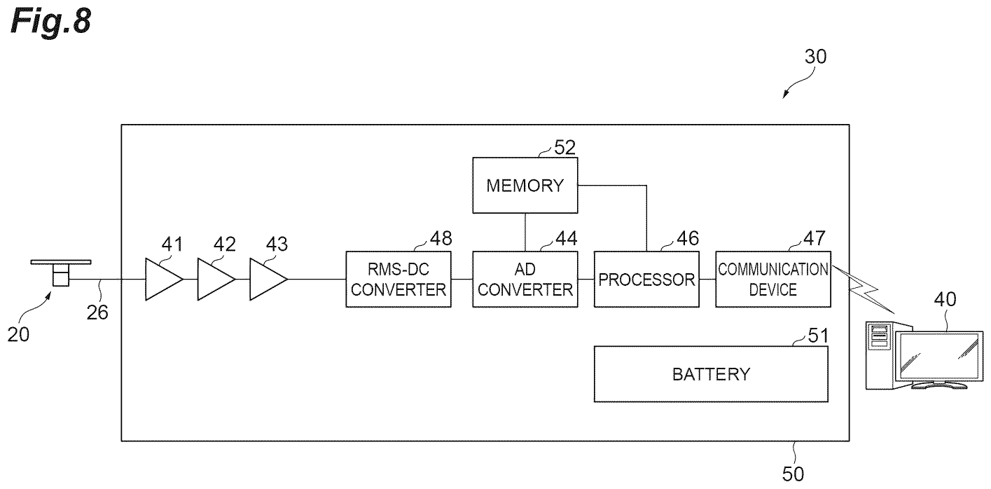

Next, a second configuration example of the intensity measuring device 30 will be described. FIG. 8 illustrates a second configuration example of the intensity measuring device 30. As illustrated in FIG. 8, the intensity measuring device 30 according to the second configuration example includes, as physical components, the charge amplifier 41, the variable gain 42, the filter 43, the AD converter 44, the processor 46, the communication device 47, and an RMS-DC converter 48. The charge amplifier 41, the variable gain 42, the filter 43, the AD converter 44, the processor 46, the communication device 47, and the RMS-DC converter 48 are mounted on the same substrate 50, and operate by the power of the battery 51.

That is, the intensity measuring device 30 according to the second configuration example is different from the intensity measuring device 30 according to the first configuration example in that the RMS-DC converter 48 is provided instead of the FPGA 45. Hereinafter, differences from the intensity measuring device 30 according to the first configuration example will be mainly described, and redundant description will be omitted.

The RMS-DC converter 48 is a circuit that outputs an output value indicating an effective value of an AE signal waveform. For example, an input of the RMS-DC converter 48 is the AE signal waveform illustrated in FIG. 4, and an output of the RMS-DC converter 48 is the effective value that changes with time illustrated in FIG. 5. In the second configuration example, the RMS-DC converter 48 configures the time-series data generation unit 32.

In the embodiment, as illustrated in FIG. 8, the RMS-DC converter 48 is disposed between the filter 43 and the AD converter 44, receives the AE signal waveform output from the filter 43 as input, and outputs an output value indicating the effective value of the AE signal waveform. The output value output from the RMS-DC converter 48 is a voltage value according to the effective value of the AE signal waveform that changes with time, and can be said to be time-series data of the effective value. The AD converter 44 samples the output value output from the RMS-DC converter 48 at a predetermined frequency and converts the output value into digital data.

The processor 46 calculates an average value of the effective values based on the digital data of the effective value output from the AD converter 44. For example, the processor 46 extracts a plurality of effective values included in a predetermined time length L from the digital data of the effective value, and calculates an average value of the plurality of effective values.

In addition, the processor 46 calculates an intensity of the shot processing based on the calculated average value of the effective values. For example, the processor 46 reads a model equation according to a type of the shot media 2 from the memory 52, and calculates an intensity corresponding to the average value of the effective values using the model equation. The calculated intensity is transmitted to the external device 40 by the communication device 47.

As described above, in the intensity measuring device 30 according to the second configuration example, since the time-series data of the effective value is generated using the RMS-DC converter 48, a calculation amount of the processor 46 can be reduced. Therefore, it is possible to increase a measurement speed of the intensity.

As described above, in the intensity measuring device 30 described above, the intensity of the shot processing is obtained from the average value of the effective values. Since there is a certain correlation between the average value of the effective values and the intensity, the intensity of the shot processing can be obtained from the average value of the effective values without measuring an arc-height of a test piece by using a microgauge. In particular, as indicated in Equation (4), since the average value of the effective values and the intensity can be represented by a relationship of a polynomial with one variable, the intensity of the shot processing can be calculated from the average value of the effective values without complicated calculation. Therefore, a calculation load of the intensity measuring device 30 can be reduced. In addition, since the effective value of the AE signal waveform fluctuates with time, when the intensity is obtained from an instantaneous value of the effective value, there is a possibility that the intensity deviating from a true intensity is output. Therefore, by estimating the intensity using the average value of the effective values, an estimated value of the intensity can be brought close to the true intensity.

The operator of the shot processing system 1 compares an intensity (hereinafter, referred to as “required intensity”) required to apply a desired compressive residual stress with an intensity (hereinafter, referred to as “measured intensity”) measured by the intensity measuring device 30, and determines whether or not a difference between the required intensity and the measured intensity falls within a specified management range. In a case where the difference between the required intensity and the measured intensity is within the specified management range, the shot media 2 are projected onto the processing object under the set projection condition.

On the other hand, in a case where the difference between the required intensity and the measured intensity does not fall within the specified management range, the projection condition of the shot processing device 10 is corrected so that the difference between the required intensity and the measured intensity becomes small. For example, in a case where the measured intensity is smaller than the required intensity, the projection condition is corrected so that the injection pressure or the injection amount of the shot media 2 increases, and the shot media 2 are projected onto the processing object under the corrected projection condition. On the contrary, in a case where the measured intensity is larger than the required intensity, the projection condition is corrected so that the injection pressure or the injection amount of the shot media 2 becomes small, and the shot medium 2 is projected onto the processing object under the corrected projection condition. As a result, a desired compressive residual stress can be applied to the processing object.

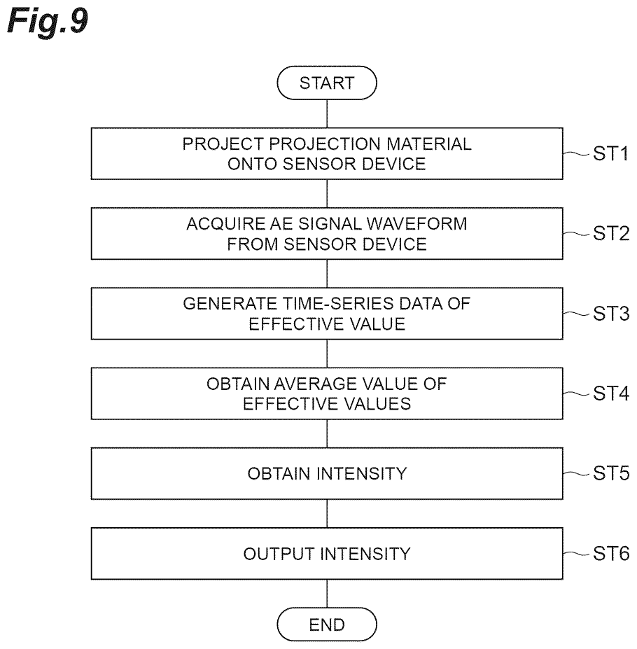

Next, an intensity measuring method for measuring an intensity of shot processing using the above-described intensity measuring device 30 will be described. FIG. 9 is a flowchart illustrating an intensity measuring method according to the embodiment.

In this method, first, the shot media 2 are projected from the shot processing device 10 onto the surface 21a of the sensor device 20 (step ST1). When the shot media 2 collide with the surface 21a, a part of strain energy is emitted as an elastic wave along with deformation or destruction of the collision member 21. The sensor device 20 measures the elastic wave generated by the collision of the shot media 2 and outputs the elastic wave as an AE signal waveform.

Next, the waveform acquisition unit 31 of the intensity measuring device 30 acquires the AE signal waveform from the sensor device 20 (step ST2). Next, the time-series data generation unit 32 generates time-series data of an effective value of the AE signal waveform (step ST3). The time-series data of the effective value may be generated by calculating the effective value at each time by the FPGA 45 or the processor 46 based on Equation (1) described above, or may be generated by using the RMS-DC converter 48.

Next, the average value acquisition unit 33 obtains an average value of the effective values for a predetermined time length L (step ST4). The average value of the effective values is acquired by the FPGA 45 or the processor 46 extracting a plurality of effective values included in the predetermined time length L from the time-series data of the effective value and calculating an average value of the plurality of effective values.

Next, the intensity acquisition unit 34 obtains an intensity of the shot processing based on the average value of the effective values (step ST5). For example, the intensity is calculated by the FPGA 45 or the processor 46 applying the average value of the effective values to Equation (4) described above.

Next, the communication unit 35 outputs the obtained intensity to the external device 40 (step ST6). The external device 40 displays the intensity measured by the sensor device 20 on the display device. The operator of the shot processing system 1 sets the projection condition of the shot processing device 10 based on the displayed intensity.

Although the intensity measuring device, the intensity measuring system, and the intensity measuring method according to various embodiments have been described above, the present invention is not limited to the above-described embodiments, and various modifications can be made without changing the gist of the invention. That is, it should be noted that the above embodiments are intended for the purpose of illustration and are not intended to limit the scope of the present invention.

For example, in the above-described embodiment, the intensity measuring device 30 measures the intensity from the AE signal waveform output from the sensor device 20, but the intensity measuring device 30 can measure the intensity from the AE signal waveform output from any sensor. For example, as illustrated in FIG. 1, in a case where the AE sensor 23 for measuring an elastic wave is provided in the nozzle 15 of the shot processing device 10, the intensity measuring device 30 may measure the intensity of the shot processing based on the AE signal waveform output from the AE sensor 23. In this case, the intensity of the shot processing can be measured based on the AE signal waveform indicating the elastic wave generated in the nozzle 15 when the shot media 2 are projected.

Further, in the first configuration example illustrated in FIG. 7, at least a part of the generation processing of the time-series data of the effective value, the calculation processing of the average value of the effective values, and the calculation processing of the intensity are allocated to the FPGA 45, but in the embodiment, at least a part of these processing may be allocated to an application specific integrated circuit (ASIC).

Further, in the second configuration example illustrated in FIG. 8, the RMS-DC converter 48 is used instead of the FPGA 45, but the intensity measuring device 30 may include both the FPGA 45 and the RMS-DC converter 48, and at least a part of the calculation processing of the average value of the effective values and the calculation processing of the intensity may be allocated to the FPGA 45.

The above various embodiments can be combined within a range having no contradiction.

### MODES INCLUDED IN PRESENT DISCLOSURE

The present disclosure includes the modes set forth in the following clauses.
(Clause 1) An intensity measuring device according to one aspect is connected to a sensor device that outputs a signal waveform related to an elastic wave generated by shot processing, and measures an intensity of the shot processing based on the signal waveform. The intensity measuring device includes a waveform acquisition unit configured to acquire the signal waveform from the sensor device; a time-series data generation unit configured to generate time-series data of an effective value of the signal waveform; an average value acquisition unit configured to obtain an average value of the effective values for a predetermined time length based on the time-series data; and an intensity acquisition unit configured to obtain the intensity of the shot processing based on the average value of the effective values. There is a certain correlation between the average value of the effective values and the intensity of the shot processing. In the intensity measuring device according to the present aspect, since the intensity is obtained from the average value of the effective values, the intensity of the shot processing can be acquired without measuring an arc-height of a test piece by using a microgauge. Therefore, the intensity can be easily measured in a short time.
(Clause 2) In the intensity measuring device described in Clause 1, the intensity acquisition unit may calculate an intensity y based on the following Equation (1),

$$[ Equation 7 ]$$

$$y = {\sum }_{k = 0}^{n} {a}_{k} {x}^{k} \qquad ( 1 )$$

where, aₖ is a constant and x is the average value of the effective values.

As indicated in Equation (1), the average value of the effective values and the intensity of the shot processing can be represented by a relationship of a polynomial. By calculating the intensity of the shot processing using such a simple calculation equation as described above, a calculation load of the intensity can be reduced.
(Clause 3) The intensity measuring device described in Clause 1 or 2 may further include a communication unit configured to send the intensity to an external device. By transmitting the intensity to the external device, an amount of data transfer to the external device can be reduced as compared with a case where the signal waveform is transmitted to the external device.
(Clause 4) The intensity measuring device described in any one of Clauses 1 to 3 may further include an amplifier configuring the waveform acquisition unit; an FPGA configuring the time-series data generation unit; and an AD converter, the amplifier may amplify the signal waveform output from the sensor device, the AD converter may sample the amplified signal waveform and convert the signal waveform into digital data, and the FPGA may generate time-series data of the effective value from the digital data. In order to generate the time-series data of the effective value, a large amount of calculation is required, and it takes a long time. By allocating the processing of generating the time-series data of the effective value to the FPGA, a measurement time of the intensity can be shortened.
(Clause 5) In the intensity measuring device described in Clause 4, the FPGA may calculate the average value of the effective values in a predetermined time length from the time-series data of the effective value. By allocating the processing of calculating the average value of the effective values to the FPGA, the measurement time of the intensity can be further shortened.
(Clause 6) In the intensity measuring device described in Clause 4 or 5, the amplifier, the FPGA, and the AD converter may be disposed on a same substrate. In this case, it is possible to downsize the intensity measuring device.
(Clause 7) The intensity measuring device described in any one of Clauses 1 to 3 may further include an amplifier configuring the waveform acquisition unit; an RMS-DC converter configuring the time-series data generation unit; and an AD converter, the amplifier may amplify the signal waveform output from the sensor device, the RMS-DC converter may receive the signal waveform and output an output value indicating the effective value of the signal waveform that changes with time, and the AD converter may sample the output value and convert the effective value of the signal waveform into digital data. In this case, since the output value indicating the effective value of the signal waveform is output from the RMS-DC converter, a calculation load of the effective value of the signal waveform can be reduced. Therefore, the intensity can be efficiently measured.
(Clause 8) The intensity measuring device described in Clause 7 may further include a processor configuring the average value acquisition unit and the intensity acquisition unit, and the processor may calculate the average value of the effective values for the predetermined time length based on the digital data, and calculate the intensity of the shot processing based on the average value of the effective values. In this case, since the intensity is calculated based on the output value output from the RMS-DC converter, a calculation load of the processor can be reduced.
(Clause 9) An intensity measuring device according to another aspect is connected to a sensor device that outputs a signal waveform related to an elastic wave generated by shot processing, and measures an intensity of the shot processing based on the signal waveform. The intensity measuring device includes a waveform acquisition unit configured to acquire the signal waveform from the sensor device; and
an output unit configured to output the intensity of the shot processing based on the signal waveform, and an intensity y output from the output unit satisfies the following Equation (2),

$$[ Equation 8 ]$$

$$y = {\sum }_{k = 0}^{n} {a}_{k} {x}^{k} \qquad ( 2 )$$

where, aₖ is a constant, and x is an average value of effective values of the signal waveform for a predetermined time length.

As described above, in the intensity measuring device according to the present aspect, since the intensity is obtained from the average value of the effective values, the intensity can be easily measured in a short time.
(Clause 10) An intensity measuring system according to one aspect includes a sensor device configured to output a signal waveform related to an elastic wave generated by shot processing; a waveform acquisition unit configured to acquire the signal waveform from the sensor device; a time-series data generation unit configured to generate time-series data of an effective value of the signal waveform; an average value acquisition unit configured to obtain an average value of the effective values for a predetermined time length based on the time-series data; and an intensity acquisition unit configured to obtain an intensity of the shot processing based on the average value of the effective values. In the intensity measuring system, since the intensity is obtained from the average value of the effective values, the intensity can be easily measured in a short time.
(Clause 11) In the intensity measuring device described in Clause 10, the sensor device may include a collision member having a surface that receives shot media, a waveguide member having a first surface in contact with the collision member and a second surface opposite to the first surface, the waveguide member propagating the elastic wave generated by collision of the shot media from the first surface to the second surface, and an AE sensor that detects the elastic wave propagated to the second surface and outputs the signal waveform. Since the AE sensor can be protected by measuring the elastic wave propagated through the waveguide member with the AE sensor, it is possible to prevent a failure of the AE sensor.
(Clause 12) In the intensity measuring device described in Clause 10, the sensor device may include a waveguide member having a first surface that receives shot media and a second surface opposite to the first surface, the waveguide member propagating the elastic wave generated by collision of the shot media from the first surface to the second surface, and an AE sensor that detects the elastic wave propagated to the second surface and outputs the signal waveform.
(Clause 13) An intensity measuring method according to one aspect includes acquiring a signal waveform related to an elastic wave generated by shot processing from a sensor device; generating time-series data of an effective value of the signal waveform; obtaining an average value of the effective values for a predetermined time length based on the time-series data; and obtaining an intensity of the shot processing based on the average value of the effective values. In the intensity measuring method, since the intensity is obtained from the average value of the effective values, the intensity can be easily measured in a short time.

### REFERENCE SIGNS LIST

2 Shot media
20 Sensor device
21 Collision member
21a Surface
22 Waveguide member
22a First surface
22b Second surface
23 AE sensor
30 Intensity measuring device
31 Waveform acquisition unit
32 Time-series data generation unit
33 Average value acquisition unit
34 Intensity acquisition unit
35 Communication unit
40 External device
41 Charge amplifier (amplifier)
45 FPGA
46 Processor
48 RMS-DC converter

What is claimed is:

1. An intensity measuring device that is connected to a sensor device that outputs a signal waveform related to an elastic wave generated by shot processing and measures an intensity of the shot processing based on the signal waveform, the intensity measuring device comprising:
a waveform acquisition unit configured to acquire the signal waveform from the sensor device;
a time-series data generation unit configured to generate time-series data of an effective value of the signal waveform;
an average value acquisition unit configured to obtain an average value of the effective values for a predetermined time length based on the time-series data; and
an intensity acquisition unit configured to obtain the intensity of the shot processing based on the average value of the effective values.

2. The intensity measuring device according to claim 1, wherein the intensity acquisition unit calculates the intensity y based on the following Equation (1),
$$[ Equation 1 ]$$
$$y = {\sum }_{k = 0}^{n} {a}_{k} {x}^{k} \qquad ( 1 )$$
where, aₖ is a constant and x is the average value of the effective values.

3. The intensity measuring device according to claim 1, further comprising a communication unit configured to send the intensity to an external device.

4. The intensity measuring device according to claim 1, further comprising:
an amplifier configuring the waveform acquisition unit;
an FPGA configuring the time-series data generation unit; and
an AD converter, wherein
the amplifier amplifies the signal waveform output from the sensor device,
the AD converter samples the amplified signal waveform and converts the signal waveform into digital data, and
the FPGA calculates the effective value at each time from the digital data and generates time-series data of the effective value.

5. The intensity measuring device according to claim 4, wherein the FPGA calculates the average value of the effective values for the predetermined time length based on the effective value at each time.

6. The intensity measuring device according to claim 4, wherein the amplifier, the FPGA, and the AD converter are disposed on a same substrate.

7. The intensity measuring device according to claim 1, further comprising:
an amplifier configuring the waveform acquisition unit;
an RMS-DC converter configuring the time-series data generation unit; and
an AD converter, wherein
the amplifier amplifies the signal waveform output from the sensor device,
the RMS-DC converter receives the signal waveform as input and outputs an output value indicating the effective value of the signal waveform that changes with time, and
the AD converter samples the output value and converts the effective value of the signal waveform into digital data.

8. The intensity measuring device according to claim 7, further comprising:
a processor configuring the average value acquisition unit and the intensity acquisition unit, wherein
the processor calculates the average value of the effective values for the predetermined time length based on the digital data, and calculates the intensity of the shot processing based on the average value of the effective values.

9. An intensity measuring device that is connected to a sensor device that outputs a signal waveform related to an elastic wave generated by shot processing and measures an intensity of the shot processing based on the signal waveform, the intensity measuring device comprising:
a waveform acquisition unit configured to acquire the signal waveform from the sensor device; and
an output unit configured to output the intensity of the shot processing based on the signal waveform, wherein
the intensity y output from the output unit satisfies the following Equation (2),
$$[ Equation 2 ]$$
$$y = {\sum }_{k = 0}^{n} {a}_{k} {x}^{k} \qquad ( 2 )$$
where, aₖ is a constant, and x is an average value of effective values of the signal waveform for a predetermined time length.

10. An intensity measuring system comprising:
a sensor device configured to output a signal waveform related to an elastic wave generated by shot processing;
a waveform acquisition unit configured to acquire the signal waveform from the sensor device;
a time-series data generation unit configured to generate time-series data of an effective value of the signal waveform;
an average value acquisition unit configured to obtain an average value of the effective values for a predetermined time length based on the time-series data; and
an intensity acquisition unit configured to obtain an intensity of the shot processing based on the average value of the effective values.

11. The intensity measuring system according to claim 10, wherein
the sensor device includes:
a collision member having a surface that receives shot media,
a waveguide member having a first surface in contact with the collision member and a second surface opposite to the first surface, the waveguide member propagating the elastic wave generated by collision of the shot media from the first surface to the second surface, and
an AE sensor that detects the elastic wave propagated to the second surface and outputs the signal waveform.

12. The intensity measuring system according to claim 10, wherein
the sensor device includes:
a waveguide member having a first surface that receives shot media and a second surface opposite to the first surface, the waveguide member propagating the elastic wave generated by collision of the shot media from the first surface to the second surface, and
an AE sensor that detects the elastic wave propagated to the second surface and outputs the signal waveform.

13. An intensity measuring method comprising:
acquiring a signal waveform related to an elastic wave generated by shot processing from a sensor device;
generating time-series data of an effective value of the signal waveform;
obtaining an average value of the effective values for a predetermined time length based on the time-series data; and
obtaining an intensity of the shot processing based on the average value of the effective values.
